(19) United States
(12) Patent Application Publication
(10) Pub. No.: US 2016/0130438 A1
(43) Pub. Date: May 12, 2016

(54) MOLDED ARTICLE AND COMPOSITION USED IN ITS FABRICATION

(71) Applicant: SABIC GLOBAL TECHNOLOGIES B.V., Bergen op Zoom (NL)

(72) Inventors: Kristopher Rexius, Selkirk, NY (US); Andrew Sics, Wixom, MI (US); Sai-Pei Ting, Slingerlands, NY (US)

(21) Appl. No.: 14/888,957

(22) PCT Filed: Jul. 15, 2014
(86) PCT No.: PCT/US14/46612

§ 371 Date: Nov. 4, 2015

Related U.S. Application Data
(60) Provisional application No. 61/858,174, filed on Jul. 25, 2013.

(51) Int. Cl. C08L 77/06

(52) U.S. Cl. CPC C08L 77/06

(57) ABSTRACT

A variety of molded articles are formed from a composition that includes 35 to 55 weight percent glass fibers and 45 to 65 weight percent of a compatibilized blend prepared by melt blending components that include 30 to 44 weight percent of a polyamide, 12 to 23 weight percent of a poly(phenylene ether), and 0.1 to 1 weight percent of a compatibilizing agent for the poly amide and the poly(phenylene ether).

### BACKGROUND OF THE INVENTION

Poly(phenylene ether)s have been blended with polyamides to provide compositions having a wide variety of beneficial properties such as heat resistance, chemical resistance, impact strength, hydrolytic stability, and dimensional stability. Glass fiber-filled poly(phenylene ether)-polyamide blends have been used to mold a variety of articles for use in automotive and fluid engineering applications, among many others. However, there remains a need for molded articles that provide improvements in one or more of flexural strength, heat resistance, chemical resistance, vibration resistance, crack resistance, and dimensional stability.

### BRIEF SUMMARY OF EMBODIMENTS OF THE INVENTION

One embodiment is a molded article comprising a composition comprising: 45 to 65 weight percent of a compatibilized blend comprising the product of melt blending components comprising 30 to 44 weight percent of a polyamide-6, a polyamide-6,6, or a combination thereof, 12 to 23 weight percent of a poly(phenylene ether), and 0.1 to 1 weight percent of a compatibilizing agent; and 35 to 55 weight percent glass fibers; wherein weight percent values are based on the total weight of the composition.

Another embodiment is a composition comprising: 45 to 65 weight percent of a compatibilized blend comprising the product of melt blending components comprising 30 to 44 weight percent of polyamide-6,6, 12 to 23 weight percent of poly(2,6-dimethyl-1,4-phenylene ether), and 0.4 to 1 weight percent of a compatibilizing agent comprising citric acid, fumaric acid, maleic acid, maleic anhydride, or a combination thereof; and 35 to 55 weight percent of glass fibers; wherein weight percent values are based on the total weight of the composition.

These and other embodiments are described in detail below.

### DETAILED DESCRIPTION OF THE INVENTION

The present inventors have determined that improvements in one or more of flexural strength, heat resistance, chemical resistance, vibration resistance, crack resistance, and dimensional stability are provided by articles molded from a specific glass-filled polyamide/poly(phenylene ether) blend.

Thus, one embodiment is an molded article comprising a composition comprising: 45 to 65 weight percent of a compatibilized blend comprising the product of melt blending components comprising 30 to 44 weight percent of a polyamide-6, a polyamide-6,6, or a combination thereof, 12 to 23 weight percent of a poly(phenylene ether), and 0.1 to 1 weight percent of a compatibilizing agent for the polyamide and the poly(phenylene ether); and 35 to 55 weight percent glass fibers; wherein weight percent values are based on the total weight of the composition.

Specific articles that can be molded from the composition include, for example, an automatic transmission oil cooler bracket, an under-the-hood support system, an under-car support system, an automotive battery tray, an electric vehicle support frame, an automotive roll-over crush zone component, an automotive powertrain housing, an automotive valve cover, an automotive intake manifold, an automotive turbo charger air intake manifold, an automotive turbo charger compressor housing, an automotive turbo charger compressor wheel, an automotive turbo charger compressed air duct, an automotive sunroof mounting or framework, an automotive window mounting or framework, an electric vehicle battery frame or support, an automotive load floor bracket or support, an automotive active grill shutter, an automotive grill opening reinforcement, an automotive mirror bracket, an automotive roof rack bracket or frame, an automotive running board component, an automotive fan support or housing or bracket, an automotive hood, an automotive hood fairing, an automotive hood trim support, an automotive seat structure, an automotive cabin structure or support or mounting device, an automotive storage container, an automotive throttle body housing, a water meter housing, a water distribution housing, a water valve, a water fitting, a water pump housing, a water filtration housing, or a water filtration support system. As used herein, the term “automotive” includes articles for any vehicle having an internal power source, including motorcycles, cars, light trucks, heavy trucks, off-road vehicles, personal recreation vehicles, and tractors.

The composition comprises a compatibilized polyamide/poly(phenylene ether) blend and glass fibers. The amount of the compatibilized blend is 45 to 65 weight percent, based on the total weight of the composition. Within this range, the compatibilized blend amount can be 55 to 65 weight percent, specifically 56 to 64 weight percent, more specifically 57 to 63 weight percent. The amount of the glass fibers is 35 to 55 weight percent, based on the total weight of the composition. Within this range, the glass fiber amount is 35 to 45 weight percent, specifically 36 to 44 weight percent, specifically 37 to 43 weight percent.

The compatibilized polyamide/poly(phenylene ether) blend comprises the product of melt blending components comprising a polyamide, a poly(phenylene ether), and a compatibilizing agent for the polyamide and the poly(phenylene ether).

The melt blended components used to form the compatibilized polyamide/poly(phenylene ether) blend include a polyamide-6, a polyamide-6,6, or a combination thereof. For brevity, the term “polyamide” is sometimes used herein to refer to polyamide-6, polyamide-6,6, or a combination thereof. In some embodiments the polyamide consists of polyamide-6. In some embodiments the polyamide consists of polyamide-6,6. In some embodiments the polyamide consists of a combination of polyamide-6 and polyamide-6,6. Methods of forming polyamide-6 and polyamide-6,6 are known, and both are commercially available.

Polyamides having an intrinsic viscosity of up to 400 milliliters per gram (mL/g) can be used, or, more specifically, having a viscosity of 90 to 350 mL/g, or, even more specifically, having a viscosity of 110 to 240 mL/g, as measured in a 0.5 weight percent solution in 96 weight percent sulfuric acid in accordance with ISO 307. The polyamide can have a relative viscosity of 20 to 60, specifically 30 to 50, determined according to ASTM D789-07e1 using a solution of 11 grams of polyamide in 100 milliliters of 90% formic acid.

In some embodiments, the polyamide has an amine end group concentration greater than or equal to 35 microequivalents amine end group per gram of polyamide (microequivalents/gram) as determined by titration with HCl. The amine end group concentration can be greater than or equal to 40 microequivalents/gram, or, more specifically, greater than or equal to 45 microequivalents/gram. Amine end group content can be determined by dissolving the polyamide in a suitable solvent, optionally with heat. The polyamide solution is titrated with 0.01 Normal hydrochloric acid (HCl) solution using a suitable indication method. The amount of amine end groups is calculated based the volume of HCl solution added to the sample, the volume of HCl used for the blank, the molarity of the HCl solution, and the weight of the polyamide sample.

The composition comprises the polyamide in an amount of 30 to 44 weight percent, based on the total weight of the composition. Within this range the polyamide amount can be 34 to 44 weight percent, 35 to 43 weight percent, specifically 36 to 42 weight percent.

In addition to the polyamide, the melt blended components used to form the compatibilized polyamide/poly(phenylene ether) blend include a poly(phenylene ether). Suitable poly(phenylene ether)s include those comprising repeating structural units having the formula

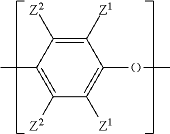

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

In some embodiments, the poly(phenylene ether) has an intrinsic viscosity of 0.25 to 1 deciliter per gram measured by Ubbelohde viscometer at 25° C. in chloroform. Within this range, the poly(phenylene ether) intrinsic viscosity can be 0.3 to 0.65 deciliter per gram, more specifically 0.35 to 0.5 deciliter per gram, even more specifically 0.4 to 0.5 deciliter per gram. For some automotive articles, it may be desirable to employ a poly(phenylene ether) having an intrinsic viscosity of 0.35 to 0.45 deciliter per gram, specifically 0.37 to 0.43 deciliter per gram. For some fluid engineering articles, it may be desirable to employ a poly(phenylene ether) having an intrinsic viscosity of 042 to 0.50 deciliter per gram, specifically 0.43 to 0.49 deciliter per gram.

In some embodiments, the poly(phenylene ether) is essentially free of incorporated diphenoquinone residues. In the context, “essentially free” means that less than 1 weight percent of poly(phenylene ether) molecules comprise the residue of a diphenoquinone. As described in U.S. Pat. No. 3,306,874 to Hay, synthesis of poly(phenylene ether) by oxidative polymerization of monohydric phenol yields not only the desired poly(phenylene ether) but also a diphenoquinone as side product. For example, when the monohydric phenol is 2,6-dimethylphenol, 3,3′,5,5′-tetramethyldiphenoquinone is generated. Typically, the diphenoquinone is “reequilibrated” into the poly(phenylene ether) (i.e., the diphenoquinone is incorporated into the poly(phenylene ether) structure) by heating the polymerization reaction mixture to yield a poly(phenylene ether) comprising terminal or internal diphenoquinone residues). For example, when a poly(phenylene ether) is prepared by oxidative polymerization of 2,6-dimethylphenol to yield poly(2,6-dimethyl-1,4-phenylene ether) and 3,3′,5,5′-tetramethyldiphenoquinone, reequilibration of the reaction mixture can produce a poly(phenylene ether) with terminal and internal residues of incorporated diphenoquinone. However, such reequilibration reduces the molecular weight of the poly(phenylene ether). Accordingly, when a higher molecular weight poly(phenylene ether) is desired, it may be desirable to separate the diphenoquinone from the poly(phenylene ether) rather than reequilibrating the diphenoquinone into the poly(phenylene ether) chains. Such a separation can be achieved, for example, by precipitation of the poly(phenylene ether) in a solvent or solvent mixture in which the poly(phenylene ether) is insoluble and the diphenoquinone is soluble. For example, when a poly(phenylene ether) is prepared by oxidative polymerization of 2,6-dimethylphenol in toluene to yield a toluene solution comprising poly(2,6-dimethyl-1,4-phenylene ether) and 3,3′,5,5′-tetramethyldiphenoquinone, a poly(2,6-dimethyl-1,4-phenylene ether) essentially free of diphenoquinone can be obtained by mixing 1 volume of the toluene solution with 1 to 4 volumes of methanol or a methanol/water mixture. Alternatively, the amount of diphenoquinone side-product generated during oxidative polymerization can be minimized (e.g., by initiating oxidative polymerization in the presence of less than 10 weight percent of the monohydric phenol and adding at least 95 weight percent of the monohydric phenol over the course of at least 50 minutes), and/or the reequilibration of the diphenoquinone into the poly(phenylene ether) chain can be minimized (e.g., by isolating the poly(phenylene ether) no more than 200 minutes after termination of oxidative polymerization). These approaches are described in U.S. Pat. No. 8,025,158 to Delsman et al. In an alternative approach utilizing the temperature-dependent solubility of diphenoquinone in toluene, a toluene solution containing diphenoquinone and poly(phenylene ether) can be adjusted to a temperature of 25° C., at which diphenoquinone is poorly soluble but the poly(phenylene ether) is soluble, and the insoluble diphenoquinone can be removed by solid-liquid separation (e.g., filtration).

In some embodiments, the poly(phenylene ether) comprises 2,6-dimethyl-1,4-phenylene ether units, 2,3,6-trimethyl-1,4-phenylene ether units, or a combination thereof. In some embodiments, the poly(phenylene ether) comprises a poly(2,6-dimethyl-1,4-phenylene ether). In some embodiments, the poly(phenylene ether) comprises a poly(2,6-dimethyl-1,4-phenylene ether) having an intrinsic viscosity of 0.35 to 0.5 deciliter per gram, measured by Ubbelohde viscometer at 25° C. in chloroform. For some automotive articles, it may be desirable to employ a poly(2,6-dimethyl-1,4-phenylene ether) having an intrinsic viscosity of 0.35 to 0.45 deciliter per gram, specifically 0.37 to 0.43 deciliter per gram. For some fluid engineering articles, it may be desirable to employ a poly(2,6-dimethyl-1,4-phenylene ether) having an intrinsic viscosity of 042 to 0.50 deciliter per gram, specifically 0.43 to 0.49 deciliter per gram.

The poly(phenylene ether) can comprise molecules having aminoalkyl-containing end group(s), typically located in a position ortho to the hydroxy group. Also frequently present are tetramethyldiphenoquinone (TMDQ) end groups, typically obtained from 2,6-dimethylphenol-containing reaction mixtures in which tetramethyldiphenoquinone by-product is present. The poly(phenylene ether) can be in the form of a homopolymer, a copolymer, a graft copolymer, an ionomer, or a block copolymer, as well as combinations thereof.

The composition comprises the poly(phenylene ether) in an amount of 12 to 23 weight percent, based on the total weight of the composition. Within this range, the poly(phenylene ether) amount can be 15 to 23 weight percent, specifically 16 to 22 weight percent, more specifically 17 to 21 weight percent.

In addition to the polyamide and the poly(phenylene ether), the melt blended components used to form the compatibilized polyamide/poly(phenylene ether) blend include a compatibilizing agent for the polyamide and the poly(phenylene ether). As used herein, the term “compatibilizing agent” refers to a polyfunctional compound that interacts with the poly(phenylene ether), the polyamide, or both. This interaction can be chemical (for example, grafting) and/or physical (for example, affecting the surface characteristics of the dispersed phases). In either instance the resulting polyamide-poly(phenylene ether) blend exhibits improved compatibility, particularly as evidenced by enhanced impact strength, mold knit line strength, and/or tensile elongation. As used herein, the expression “compatibilized blend” refers to compositions that have been physically and/or chemically compatibilized with a compatibilizing agent, as well as blends of poly(phenylene ether)s and polyamides that are compatibilized without the use of a compatibilizing agent, as is the case, for example, when compatibilization is derived from compatibility-enhancing dibutylaminomethyl substituents on the poly(phenylene ether).

Examples of compatibilizing agents that can be employed include liquid diene polymers, epoxy compounds, oxidized polyolefin wax, quinones, organosilane compounds, polyfunctional compounds, functionalized poly(phenylene ether)s, and combinations thereof. Compatibilizing agents are further described in U.S. Pat. No. 5,132,365 to Gallucci, and U.S. Pat. Nos. 6,593,411 and 7,226,963 to Koevoets et al.

In some embodiments, the compatibilizing agent comprises a polyfunctional compound. Polyfunctional compounds that can be employed as a compatibilizing agent are typically of three types. The first type of polyfunctional compound has in the molecule both (a) a carbon-carbon double bond or a carbon-carbon triple bond and (b) at least one carboxylic acid, anhydride, amide, ester, imide, amino, epoxy, orthoester, or hydroxy group. Examples of such polyfunctional compounds include maleic acid; maleic anhydride; fumaric acid; glycidyl acrylate, itaconic acid; aconitic acid; maleimide; maleic hydrazide; reaction products resulting from a diamine and maleic anhydride, maleic acid, fumaric acid, and the like; dichloro maleic anhydride; maleic acid amide; unsaturated dicarboxylic acids (for example, acrylic acid, butenoic acid, methacrylic acid, ethylacrylic acid, pentenoic acid, decenoic acids, undecenoic acids, dodecenoic acids, linoleic acid, and the like); esters, acid amides or anhydrides of the foregoing unsaturated carboxylic acids; unsaturated alcohols (for example, alkanols, crotyl alcohol, methyl vinyl carbinol, 4-pentene-1-ol, 1,4-hexadiene-3-ol, 3-butene-1,4-diol, 2,5-dimethyl-3-hexene-2,5-diol, and alcohols of the formula C₁₁H₂ₙ₋₅OH, CₙH₂ₙ₋₇OH and CₙH₂ₙ₋₉OH, wherein n is a positive integer from 10 to 30); unsaturated amines resulting from replacing from replacing the —OH group(s) of the above unsaturated alcohols with —NH₂ group(s); functionalized diene polymers and copolymers; and combinations comprising one or more of the foregoing. In some embodiments, the compatibilizing agent comprises maleic anhydride and/or fumaric acid.

The second type of polyfunctional compatibilizing agent has both (a) a group represented by the formula (OR) wherein R is hydrogen or an alkyl, aryl, acyl or carbonyl dioxy group and (b) at least two groups each of which can be the same or different selected from carboxylic acid, acid halide, anhydride, acid halide anhydride, ester, orthoester, amide, imido, amino, and various salts thereof. Typical of this group of compatibilizing agents are the aliphatic polycarboxylic acids, acid esters, and acid amides represented by the formula:

(R^{I}O)ₘR′(COOR^{II})ₙ(CONR^{III}R^{IV})ₛ

wherein R′ is a linear or branched chain, saturated aliphatic hydrocarbon having 2 to 20, or, more specifically, 2 to 10, carbon atoms; R^{I} is hydrogen or an alkyl, aryl, acyl, or carbonyl dioxy group having 1 to 10, or, more specifically, 1 to 6, or, even more specifically, 1 to 4 carbon atoms; each R^{II} is independently hydrogen or an alkyl or aryl group having 1 to 20, or, more specifically, 1 to 10 carbon atoms; each R^{III} and R^{IV} are independently hydrogen or an alkyl or aryl group having 1 to 10, or, more specifically, 1 to 6, or, even more specifically, 1 to 4, carbon atoms; m is equal to 1 and (n+s) is greater than or equal to 2, or, more specifically, equal to 2 or 3, and n and s are each greater than or equal to zero and wherein (OR^{I}) is alpha or beta to a carbonyl group and at least two carbonyl groups are separated by 2 to 6 carbon atoms. Obviously, R^{I}, R^{II}, R^{III}, and R^{IV} cannot be aryl when the respective substituent has less than 6 carbon atoms.

Suitable polycarboxylic acids include, for example, citric acid, malic acid, and agaricic acid, including the various commercial forms thereof, such as for example, the anhydrous and hydrated acids; and combinations comprising one or more of the foregoing. In some embodiments, the compatibilizing agent comprises citric acid. Illustrative of esters useful herein include, for example, acetyl citrate, monostearyl and/or distearyl citrates, and the like. Suitable amides useful herein include, for example, N,N′-diethyl citric acid amide; N-phenyl citric acid amide; N-dodecyl citric acid amide; N,N′-didodecyl citric acid amide; and N-dodecyl malic acid. Derivatives include the salts thereof, including the salts with amines and the alkali and alkaline metal salts. Examples of suitable salts include calcium malate, calcium citrate, potassium malate, and potassium citrate.

The third type of polyfunctional compatibilizing agent has in the molecule both (a) an acid halide group and (b) at least one carboxylic acid, anhydride, ester, epoxy, orthoester, or amide group, preferably a carboxylic acid or anhydride group. Examples of compatibilizing agents within this group include trimellitic anhydride acid chloride, chloroformyl succinic anhydride, chloroformyl succinic acid, chloroformyl glutaric anhydride, chloroformyl glutaric acid, chloroacetyl succinic anhydride, chloroacetylsuccinic acid, trimellitic acid chloride, and chloroacetyl glutaric acid. In some embodiments, the compatibilizing agent comprises trimellitic anhydride acid chloride.

In some embodiments, the compatibilizing agent comprises citric acid, fumaric acid, maleic acid, maleic anhydride, or a combination thereof.

The foregoing compatibilizing agents can be added directly to the melt blend or pre-reacted with either or both of the poly(phenylene ether) and the polyamide, as well as with any other resinous materials employed in the preparation of the compatibilized polyamide-poly(phenylene ether) blend. With many of the foregoing compatibilizing agents, particularly the polyfunctional compounds, even greater improvement in compatibility is found when at least a portion of the compatibilizing agent is pre-reacted, either in the melt or in a solution of a suitable solvent, with all or a part of the poly(phenylene ether). It is believed that such pre-reacting may cause the compatibilizing agent to react with and consequently functionalize the poly(phenylene ether). For example, the poly(phenylene ether) can be pre-reacted with maleic anhydride to form an anhydride-functionalized poly(phenylene ether) that has improved compatibility with the polyamide compared to a non-functionalized poly(phenylene ether).

When a compatibilizing agent is employed in the preparation of the compatibilized polyamide-poly(phenylene ether) blend, the amount used will be dependent upon the specific compatibilizing agent chosen and the specific polymeric system to which it is added. In some embodiments, the compatibilizing agent amount is about 0.1 to about 1 weight percent, specifically about 0.2 to about 0.8 weight percent, more specifically about 0.4 to about 0.8 weight percent, based on the total weight of the compatibilized polyamide-poly(phenylene ether) blend.

The composition can, optionally, further comprise one or more additives known in the thermoplastics art. For example, the composition can, optionally, further comprise stabilizers, mold release agents, lubricants, processing aids, drip retardants, nucleating agents, UV blockers, dyes, pigments, antioxidants, anti-static agents, blowing agents, mineral oil, metal deactivators, and antiblocking agents, and combinations thereof. When present, such additives are typically used in a total amount of less than or equal to 5 weight percent, specifically less than or equal to 3 weight percent, more specifically less than or equal to 2 weight percent, based on the total weight of the composition. In some embodiments, the composition comprises a total amount of all additives of 0.01 to 2 weight percent.

The composition can, optionally, minimize or exclude components not taught herein as required or optional. For example, the melt-blended components can comprise less than or equal to 4 weight percent of impact modifiers. Within this limit, the impact modifier amount can be less than or equal to 2 weight percent, specifically less than or equal to 1 weight percent. In some embodiments, the composition excludes impact modifiers. As another example, the composition can exclude flame retardants. As yet another example, the composition can exclude electrically conductive fillers.

In a specific embodiment of the molded article, the composition consists of 55 to 65 weight percent of the compatibilized blend and 36 to 45 weight percent glass fibers; and the compatibilized blend consists of the product of melt blending components consisting of 35 to 45 weight percent of the polyamide-6,6, 16 to 23 weight percent of a poly(phenylene ether), 0.4 to 1 weight percent of the compatibilizing agent, and, optionally, 0.01 to 2 weight percent of an additive selected from the group consisting of antioxidants, stabilizers, mold release agents, lubricants, processing aids, dyes, pigments, anti-static agents, blowing agents, mineral oil, metal deactivators, antiblocking agents, and combinations thereof.

In another specific embodiment of the molded article, the poly(phenylene ether) comprises poly(2,6-dimethyl-1,4-phenylene ether); the compatibilizing agent is selected from the group consisting of citric acid, fumaric acid, maleic acid, maleic anhydride, and combinations thereof; the composition consists of 55 to 65 weight percent of the compatibilized blend and 35 to 45 weight percent glass fibers; and the compatibilized blend consists of the product of melt blending components comprising 35 to 45 weight percent of the polyamide-6,6, 16 to 23 weight percent of the poly(phenylene ether), 0.4 to 1 weight percent of the compatibilizing agent, and, optionally, 0.01 to 2 weight percent of an additive selected from the group consisting of antioxidants, stabilizers, mold release agents, lubricants, processing aids, dyes, pigments, anti-static agents, blowing agents, mineral oil, metal deactivators, antiblocking agents, and combinations thereof.

The composition can be prepared by melt-blending the components of the composition. The melt-blending can be performed using common equipment such as ribbon blenders, HENSCHEL™ mixers, BANBURY™ mixers, drum tumblers, single-screw extruders, twin-screw extruders, multi-screw extruders, and co-kneaders. For example, the present composition can be prepared by melt-blending the components in a twin-screw extruder at a temperature of 245 to 275° C., specifically 250 to 270° C.

The article is molded. Molding methods suitable for forming the article include injection molding, gas assist injection molding, structural foam molding, compression molding, thermoforming, pressure forming, hydroforming, and vacuum forming. Combinations of the foregoing molding methods can be used. Molding conditions can be determined by the skilled person without undue experimentation. For example, injection molding can utilize a barrel temperature of 265 to 305° C. and a mold temperature of 75 to 120° C.

Any of the above-described variations in the composition can be used to form any of the molded articles described herein.

In some embodiments, the molded article is an automatic transmission oil cooler bracket. Automatic transmission oil cooler brackets are known and described, for example, in U.S. Pat. No. 7,175,142 B2 to Brown and U.S. Pat. No. 8,312,950 to Contardi et al.

In some embodiments, the molded article is an automotive under-the-hood support system. Automotive under-the-hood support systems are known and described, for example, in U.S. Pat. No. 6,681,876 to Haneda et al.

In some embodiments, the molded article is an automotive under-car support system. Automotive under-car support systems are known and described, for example, in U.S. Pat. No. 7,540,345 to Bigsby et al., U.S. Pat. No. 8,087,486 to Yamamuro et al., U.S. Pat. No. 8,146,701 to Spannbauer, and U.S. Pat. No. 8,424,819 to Tsuzuki et al.

In some embodiments, the molded article is an automotive battery tray. Automotive battery trays are known and described, for example, in U.S. Pat. No. 4,327,809 to Fenstermaker and U.S. Patent Application Publication No. US 2011/0036654 A1 to Rinderlin et al.

In some embodiments, the molded article is an electric vehicle support frame. Electric vehicle support frames are known and described, for example, in U.S. Patent Application Publication Nos. US 2013/0032427 A1 of Ishikawa et al. and US 2013/0119760 of Amano et al.

In some embodiments, the molded article is an automotive roll-over crush zone component (i.e., a component functioning to reduce roof crush in the event of a roll-over). Automotive roll-over crush zone components are known and described, for example, in U.S. Pat. No. 7,494,178 B2 to Nygaard and U.S. Pat. No. 8,047,603 to Goral et al.

In some embodiments, the molded article is an automotive powertrain housing. Automotive powertrain housings are known and described, for example, in U.S. Pat. No. 6,354,173 to Pritchard et al. and U.S. Pat. No. 7,847,444 to Kingman et al.

In some embodiments, the molded article is an automotive valve cover. Automotive valve covers are known and described, for example, in U.S. Patent Application Publication Nos. US 2002/0112684 A1 of Jones et al. and US 2009/0044773 A1 of Hu et al.

In some embodiments, the molded article is an automotive intake manifold. Automotive intake manifolds are known and described, for example, in U.S. Pat. No. 8,424,502 to Takakuwa et al. and U.S. Patent Application Publication No. US 2013/0139777 A1 of Newman et al.

In some embodiments, the molded article is an automotive turbo charger air intake manifold. Automotive turbo charger air intake manifolds are known and described, for example, in U.S. Pat. No. 4,911,135 to Nishimura et al.

In some embodiments, the molded article is an automotive turbo charger compressor housing. Automotive turbo charger compressor housings are known and described, for example, in U.S. Patent Application Publication No. US 2006/0165524 A1 of Pellkofer et al.

In some embodiments, the molded article is an automotive turbo charger compressor wheel. Automotive turbo charger compressor wheels are known and described, for example, in U.S. Patent Application Publication No. US 2006/0165524 A1 of Pellkofer et al.

In some embodiments, the molded article is an automotive turbo charger compressed air duct. Automotive turbo charger compressed air ducts are known and described, for example, in U.S. Pat. No. 4,911,135 to Nishimura et al.

In some embodiments, the molded article is an automotive sunroof mounting or framework. Automotive sunroof mountings and frameworks are known and described, for example, in U.S. Patent Application Publication Nos. US 2006/0255628 A1 of Perez Oca et al. and US 2013/0082488 A1 of Gruss et al.

In some embodiments, the molded article is an automotive window mounting or framework. Automotive window mountings and frameworks are known and described, for example, in U.S. Pat. No. 5,317,835 to Dupuy et al. and European Patent No. EP 1 498 294 B1 to Munoz Martinez et al.

In some embodiments, the molded article is an electric vehicle battery frame or support. Electric vehicle battery frames and supports are known and described, for example, in U.S. Patent Application Publication Nos. US 2013/0075173 A1 of Kato et al. and US 2013/0126255 A1 of Saeki.

In some embodiments, the molded article is an automotive load floor bracket or support. Automotive load floor brackets and supports are known and described, for example, in U.S. Pat. No. 6,945,594 of Bejin et al. and U.S. Pat. No. 8,157,318 to Paschek et al.

In some embodiments, the molded article is an automotive active grill shutter. Automotive active grill shutters are known and described, for example, in U.S. Pat. No. 7,498,926 to Browne et al. and U.S. Patent Application Publication No. US 2013/0092463 A1 of Hori.

In some embodiments, the molded article is an automotive grill opening reinforcement. Automotive grill opening reinforcements are known and described, for example, in U.S. Pat. No. 6,386,624 to Schultz et al. and U.S. Pat. No. 7,007,385 to Tarahomi.

In some embodiments, the molded article is an automotive mirror bracket. Automotive mirror brackets are known and described, for example, in U.S. Pat. No. 8,267,559 to DeLine et al. and U.S. Patent Application Publication No. US 2012/0314316 A1 of Lynam.

In some embodiments, the molded article is an automotive roof rack bracket or frame. Automotive roof rack brackets and frames are known and described, for example, in U.S. Pat. No. 6,427,888 to Condon et al. and European Patent Application Publication No. EP 1 842 728 A1 of Picton et al.

In some embodiments, the molded article is an automotive running board component. Automotive running board components are known and described, for example, in U.S. Pat. No. 7,322,593 to Smith et al. and U.S. Patent Application Publication No. US 2013/0153055 of Gaffoglio.

In some embodiments, the molded article is an automotive fan support or housing or bracket. Automotive fan supports and housings and brackets are known and described, for example, in U.S. Pat. No. 5,498,130 to Wakley et al. and U.S. Pat. No. 7,971,581 to Guilas.

In some embodiments, the molded article is an automotive hood. Automotive hoods are known and described, for example, in U.S. Pat. No. 7,815,249 B2 to Seksaria et al., and U.S. Patent Application Publication No. 2013/0106142 A1 of Yonezawa et al.

In some embodiments, the molded article is an automotive hood fairing. Automotive hood fairings are known and described, for example, in U.S. Patent Application Publication No. US 2013/0140103 A1 of Smith.

In some embodiments, the molded article is an automotive hood trim support. Automotive hood trim supports are known and described, for example, in U.S. Pat. No. 6,637,810 to Kisiler et al., European Patent No. EP 0 634 316 B1 to Davies et al.

In some embodiments, the molded article is an automotive seat structure. Automotive seat structures are known and described, for example, in U.S. Pat. No. 8,434,826 to Zynda et al. and U.S. Patent Application Publication No. US 2012/0223565 of Yasui et al.

In some embodiments, the molded article is an automotive cabin structure or support or mounting device. Automotive cabin structures and supports and mounting devices are known and described, for example, in U.S. Pat. No. 7,077,449 of Tokunaga, and International Patent Application Publication No. WO 2004/089728 A1 of Bjorkgard et al.

In some embodiments, the molded article is an automotive storage container. Automotive cabin structures and supports and mounting devices are known and described, for example, in U.S. Pat. No. 7,032,956 to Gehman et al. and U.S. Pat. No. 7,300,088 to Catenacci et al.

In some embodiments, the molded article is an automotive throttle body housing. Automotive throttle body housings are known and described, for example, in U.S. Pat. No. 6,772,795 to Chini et al. and U.S. Patent Application Publication No. 2013/0081594 A1 of Schwulst.

In some embodiments, the molded article is a water meter housing. Water meter housings are known and described, for example, in U.S. Pat. No. 5,339,686 to DeJarlais et al. and U.S. Pat. No. 7,143,645 to Benson et al., and U.S. Patent Application Publication No. US 2013/0139610 A1 of Laursen et al.

In some embodiments, the molded article is a water distribution housing. Water distribution housings are known and described, for example, in U.S. Patent Application Publication No. US 2012/0318389 A1 of Holstein (where they is referred to as “water distribution elements”).

In some embodiments, the molded article is a water valve. Water valves are known and described, for example, in U.S. Pat. No. 8,356,622 B2 to Wears et al. and U.S. Pat. No. 8,469,059 of Forst.

In some embodiments, the molded article is a water fitting. Water fittings are known and described, for example, in U.S. Patent Application Publication Nos. US 2012/0305095 A1 of Zittrer and US 2013/0061383 A1 of Hartmann et al.

In some embodiments, the molded article is a water pump housing. Water pump housings are known and described, for example, in U.S. Pat. No. 7,416,383 B2 to Burgess, and U.S. Patent Application Publication No. 2013/0145758 A1 of Michalski et al.

In some embodiments, the molded article is a water filtration housing. Water filtration housings are known and described, for example, in U.S. Pat. No. 7,635,426 to Weinstein et al., and U.S. Patent Application Publication No. US 2013/0062266 A1 of Homer et al.

In some embodiments, the molded article is a water filtration support system. Water filtration support systems are known and described, for example, in U.S. Pat. No. 6,261,453 B2 to Savage, and International Patent Application Publication No. WO 2012/081027 A2 of Ben-Horin et al.

One embodiment is a composition comprising: 55 to 65 weight percent of a compatibilized blend comprising the product of melt blending components comprising 35 to 45 weight percent of polyamide-6,6, 16 to 23 weight percent of poly(2,6-dimethyl-1,4-phenylene ether), and 0.4 to 1 weight percent of a compatibilizing agent comprising citric acid, fumaric acid, maleic acid, maleic anhydride, or a combination thereof; and 35 to 45 weight percent of glass fibers; wherein weight percent values are based on the total weight of the composition.

In a specific embodiment of the composition, the composition consists of the compatibilized blend and the glass fibers; and the melt blended components consist of the polyamide-6,6, the poly(2,6-dimethyl-1,4-phenylene ether), the compatibilizing agent, and, optionally, 0.01 to 2 weight percent of an additive selected from the group consisting of antioxidants, stabilizers, mold release agents, lubricants, processing aids, dyes, pigments, anti-static agents, blowing agents, mineral oil, metal deactivators, antiblocking agents, and combinations thereof.

All ranges disclosed herein are inclusive of the endpoints, and the endpoints are independently combinable with each other. Each range disclosed herein constitutes a disclosure of any point or sub-range lying within the disclosed range.

The invention includes at least the following embodiments.

### Embodiment 1

A molded article comprising a composition comprising: 45 to 65 weight percent of a compatibilized blend comprising the product of melt blending components comprising 30 to 44 weight percent of a polyamide-6, a polyamide-6,6, or a combination thereof, 12 to 23 weight percent of a poly(phenylene ether), and 0.1 to 1 weight percent of a compatibilizing agent; and 35 to 55 weight percent glass fibers; wherein weight percent values are based on the total weight of the composition.

### Embodiment 2

The molded article of embodiment 1, wherein the molded article is an automatic transmission oil cooler bracket, an under-the-hood support system, an under-car support system, an automotive battery tray, an electric vehicle support frame, an automotive roll-over crush zone component, an automotive powertrain housing, an automotive valve cover, an automotive intake manifold, an automotive turbo charger air intake manifold, an automotive turbo charger compressor housing, an automotive turbo charger compressor wheel, an automotive turbo charger compressed air duct, an automotive sunroof mounting or framework, an automotive window mounting or framework, an electric vehicle battery frame or support, an automotive load floor bracket or support, an automotive active grill shutter, an automotive grill opening reinforcement, an automotive mirror bracket, an automotive roof rack bracket or frame, an automotive running board component, an automotive fan support or housing or bracket, an automotive hood, an automotive hood fairing, an automotive hood trim support, an automotive seat structure, an automotive cabin structure or support or mounting device, an automotive storage container, an automotive throttle body housing, a water meter housing, a water distribution housing, a water valve, a water fitting, a water pump housing, a water filtration housing, or a water filtration support system.

### Embodiment 3

The molded article of embodiment 1 or 2, wherein the polyamide is a combination of polyamide-6 and polyamide-6,6.

### Embodiment 4

The molded article of embodiment 1 or 2, wherein the polyamide is polyamide-6,6.

### Embodiment 5

The molded article of any of embodiments 1-4, wherein the poly(phenylene ether) comprises repeating structural units having the formula

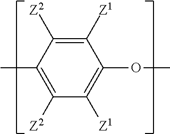

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms.

### Embodiment 6

The molded article of any of embodiments 1-5, wherein the poly(phenylene ether) comprises 2,6-dimethyl-1,4-phenylene ether units, 2,3,6-trimethyl-1,4-phenylene ether units, or a combination thereof.

### Embodiment 7

The molded article of any of embodiments 1-6, wherein the poly(phenylene ether) comprises poly(2,6-dimethyl-1,4-phenylene ether).

### Embodiment 8

The molded article of any of embodiments 1-7, wherein the compatibilizing agent comprises citric acid, fumaric acid, maleic acid, maleic anhydride, or a combination thereof.

### Embodiment 9

The molded article of any of embodiments 1-8, wherein the melt-blended components comprise less than or equal to 4 weight percent of impact modifiers.

### Embodiment 10

The molded article of any of embodiments 1-9, wherein the composition excludes flame retardants.

### Embodiment 11

The molded article of any of embodiments 1-10, wherein the composition excludes electrically conductive fillers.

### Embodiment 12

The molded article of any of embodiments 1-8, wherein the composition consists of 55 to 65 weight percent of the compatibilized blend and 35 to 45 weight percent glass fibers; and wherein the compatibilized blend consists of the product of melt blending components consisting of 35 to 45 weight percent of the polyamide-6,6, 16 to 23 weight percent of the poly(phenylene ether), 0.4 to 1 weight percent of the compatibilizing agent, and, optionally, 0.01 to 2 weight percent of an additive selected from the group consisting of antioxidants, stabilizers, mold release agents, lubricants, processing aids, dyes, pigments, anti-static agents, blowing agents, mineral oil, metal deactivators, antiblocking agents, and combinations thereof.

### Embodiment 13

The molded article of embodiment 1, wherein the poly(phenylene ether) comprises poly(2,6-dimethyl-1,4-phenylene ether); wherein the compatibilizing agent is selected from the group consisting of citric acid, fumaric acid, maleic acid, maleic anhydride, and combinations thereof; wherein the composition consists of 55 to 65 weight percent of the compatibilized blend and 35 to 45 weight percent glass fibers; and wherein the compatibilized blend consists of the product of melt blending components comprising 35 to 45 weight percent of the polyamide-6,6, 16 to 23 weight percent of the poly(phenylene ether), 0.4 to 1 weight percent of the compatibilizing agent, and, optionally, 0.01 to 2 weight percent of an additive selected from the group consisting of antioxidants, stabilizers, mold release agents, lubricants, processing aids, dyes, pigments, anti-static agents, blowing agents, mineral oil, metal deactivators, antiblocking agents, and combinations thereof.

### Embodiment 14

The molded article of any of embodiments 1-13, wherein the molded article is an automatic transmission oil cooler bracket.

### Embodiment 15

The molded article of any of embodiments 1-13, wherein the molded article is an automotive under-the-hood support system.

### Embodiment 16

The molded article of any of embodiments 1-13, wherein the molded article is an automotive under-car support system.

### Embodiment 17

The molded article of any of embodiments 1-13, wherein the molded article is an automotive battery tray.

### Embodiment 18

The molded article of any of embodiments 1-13, wherein the molded article is an electric vehicle support frame.

### Embodiment 19

The molded article of any of embodiments 1-13, wherein the molded article is an automotive roll-over crush zone component.

### Embodiment 20

The molded article of any of embodiments 1-13, wherein the molded article is an automotive powertrain housing.

### Embodiment 21

The molded article of any of embodiments 1-13, wherein the molded article is an automotive valve cover.

### Embodiment 22

The molded article of any of embodiments 1-13, wherein the molded article is an automotive intake manifold.

### Embodiment 23

The molded article of any of embodiments 1-13, wherein the molded article is an automotive turbo charger air intake manifold.

### Embodiment 24

The molded article of any of embodiments 1-13, wherein the molded article is an automotive turbo charger compressor housing.

### Embodiment 25

The molded article of any of embodiments 1-13, wherein the molded article is an automotive turbo charger compressor wheel.

### Embodiment 26

The molded article of any of embodiments 1-13, wherein the molded article is an automotive turbo charger compressed air duct.

### Embodiment 27

The molded article of any of embodiments 1-13, wherein the molded article is an automotive sunroof mounting or framework.

### Embodiment 28

The molded article of any of embodiments 1-13, wherein the molded article is an automotive window mounting or framework.

### Embodiment 29

The molded article of any of embodiments 1-13, wherein the molded article is an electric vehicle battery frame or support.

### Embodiment 30

The molded article of any of embodiments 1-13, wherein the molded article is an automotive load floor bracket or support.

### Embodiment 31

The molded article of any of embodiments 1-13, wherein the molded article is an automotive active grill shutter.

### Embodiment 32

The molded article of any of embodiments 1-13, wherein the molded article is an automotive grill opening reinforcement.

### Embodiment 33

The molded article of any of embodiments 1-13, wherein the molded article is an automotive mirror bracket.

### Embodiment 34

The molded article of any of embodiments 1-13, wherein the molded article is an automotive roof rack bracket or frame.

### Embodiment 35

The molded article of any of embodiments 1-13, wherein the molded article is an automotive running board component.

### Embodiment 36

The molded article of any of embodiments 1-13, wherein the molded article is an automotive fan support or housing or bracket.

### Embodiment 37

The molded article of any of embodiments 1-13, wherein the molded article is an automotive hood.

### Embodiment 38

The molded article of any of embodiments 1-13, wherein the molded article is an automotive hood fairing.

### Embodiment 39

The molded article of any of embodiments 1-13, wherein the molded article is an automotive hood trim support.

### Embodiment 40

The molded article of any of embodiments 1-13, wherein the molded article is an automotive seat structure.

### Embodiment 41

The molded article of any of embodiments 1-13, wherein the molded article is an automotive cabin structure or support or mounting device.

### Embodiment 42

The molded article of any of embodiments 1-13, wherein the molded article is an automotive storage container.

### Embodiment 43

The molded article of any of embodiments 1-13, wherein the molded article is an automotive throttle body housing.

### Embodiment 44

The molded article of any of embodiments 1-13, wherein the molded article is a water meter housing.

### Embodiment 45

The molded article of any of embodiments 1-13, wherein the molded article is a water distribution housing.

### Embodiment 46

The molded article of any of embodiments 1-13, wherein the molded article is a water valve.

### Embodiment 47

The molded article of any of embodiments 1-13, wherein the molded article is a water fitting.

### Embodiment 48

The molded article of any of embodiments 1-13, wherein the molded article is a water pump housing.

### Embodiment 49

The molded article of any of embodiments 1-13, wherein the molded article is a water filtration housing.

### Embodiment 50

The molded article of any of embodiments 1-13, wherein the molded article is a water filtration support system.

### Embodiment 51

A composition comprising: 45 to 65 weight percent of a compatibilized blend comprising the product of melt blending components comprising 30 to 44 weight percent of polyamide-6,6, 12 to 23 weight percent of poly(2,6-dimethyl-1,4-phenylene ether), and 0.4 to 1 weight percent of a compatibilizing agent comprising citric acid, fumaric acid, maleic acid, maleic anhydride, or a combination thereof; and 35 to 55 weight percent of glass fibers; wherein weight percent values are based on the total weight of the composition.

### Embodiment 52

The composition of embodiment 51, wherein the composition consists of 55 to 65 weight percent of the compatibilized blend and 35 to 45 weight percent of the glass fibers; and wherein the melt blended components consist of the polyamide-6,6, the poly(2,6-dimethyl-1,4-phenylene ether), the compatibilizing agent, and, optionally, 0.01 to 2 weight percent of an additive selected from the group consisting of antioxidants, stabilizers, mold release agents, lubricants, processing aids, dyes, pigments, anti-static agents, blowing agents, mineral oil, metal deactivators, antiblocking agents, and combinations thereof.

The invention is further illustrated by the following non-limiting examples.

### Examples 1-3, Comparative Examples 1-7

Components used to prepare the compositions are summarized in Table 1.

TABLE 1

| Component | Description |
|---|---|
| PPE 0.40 | Poly(2,6-dimethyl-1,4-phenylene ether), CAS Reg. No. 24938-67-8, |
| | having an intrinsic viscosity of about 0.40 deciliter per gram as measured |
| | in chloroform at 25° C.; obtained as NORYL ™ PPO ™ 640 resin from |
| | SABIC Innovative Plastics. |
| PPE 0.46 | Poly(2,6-dimethyl-1,4-phenylene ether), CAS Reg. No. 24938-67-8, |
| | having an intrinsic viscosity of about 0.46 deciliter per gram as measured |
| | in chloroform at 25° C.; obtained as NORYL ™ PPO ™ 646 resin from |
| | SABIC Innovative Plastics. |
| CA | Anhydrous citric acid, CAS Reg. No. 77-92-9. |
| SEBS | Polystyrene-poly(ethylene-butylene)-polystyrene triblock copolymer, |
| | CAS Reg. No. 66070-58-4, having a polystyrene content of about 29 |
| | weight percent; obtained as KRATON ™ G1650 from Kraton |
| | Performance Polymers Inc. |
| AO 1 | Octadecyl 3,5-di-tert-butyl-4-hydroxyhydrocinnamate, CAS Reg. No. |
| | 2082-79-3; obtained as IRGANOX ™ 1076 from BASF. |
| AO 2 | Pentaerythritol 3-(4-hydroxy-3,5-di-tert-butylphenyl)propionate (1:4), |
| | CAS Reg. No. 6683-19-8; obtained as IRGANOX ™ 1010 from BASF |
| | Corp. |
| AO 3 | 3,5-Bis(1,1-dimethylethyl)-4-hydroxybenzenepropanoic acid octadecyl |
| | ester, CAS Reg. No. 2082-79-3; obtained as IRGANOX ™ 1096 from |
| | BASF Corp. |
| Cu(OAc)₂•H₂O | Cupric acetate monohydrate, CAS Reg. No. 6049-93-1; obtained from |
| | Barker Industries. |
| CuCl₂•2H₂O | Cupric chloride dihydrate, CAS Reg. No. 10125-13-0; obtained from |
| | Barker Industries. |
| CuI | Cuprous iodide, CAS Reg. No. 7681-65-4. |
| KI solution | A 33 weight percent potassium iodide solution in water; obtained from |
| | Ajay North America Inc. |
| CB 1 | Carbon black pigment, having an iodine number of 142 milligrams/gram |
| | determined according to ASTM D1510, an oil absorption number of 118 |
| | centimeter³/100 grams determined according to ASTM D 2414, and a 325 |
| | mesh residue less than 300 parts per million determined according to |
| | ASTM D 1514; obtained as VULCAN ™ 9A32 from Cabot. |
| CB 2 | Carbon black pigment; obtained as Channel Black G from Heritage |
| | Chemical Sales. |
| CB MB 1 | A carbon black masterbatch containing 20 weight percent of CB 1 in |
| | polyamide-6,6. |
| CB MB 2 | A carbon black masterbatch containing 20 weight percent of CB 2 in |
| | polyamide-6,6; obtained as CNY08766 from Clariant. |
| PA66 1 | Polyamide-6,6, CAS Reg. No. 32131-17-2, having a relative viscosity of |
| | about 46-50 measured according to ASTM D789-07e1 in 90% formic |
| | acid; obtained in pellet form as STABAMID ™ 26 FE 1 from Rhodia. |
| PA66 2 | Polyamide-6,6, CAS Reg. No. 32131-17-2, having a relative viscosity of |
| | about 44-48 measured according to ASTM D789-07e1 in 90% formic |
| | acid; obtained in pellet form as VYDYNE ™ 21Z from Ascend. |
| PA66 3 | Polyamide-6,6, CAS Reg. No. 32131-17-2, having a relative viscosity of |
| | about 34-48 measured according to ASTM D789-07e1 in 90% formic |
| | acid; obtained in pellet form as VYDYNE ™ 21ZLV from Ascend. |
| Glass fibers 1 | Chopped glass fibers having a diameter of about 10 micrometers, a pre- |
| | compounded length of about 3.2 millimeters, and a surface treatment for |
| | compatibility with polyamide-6,6; obtained as DS 1128-10N from 3B |
| | Glass. |
| Glass fibers 2 | Chopped glass fibers having a diameter of about 10 micrometers, a pre- |
| | compounded length of about 3.2 millimeters, and a surface treatment for |
| | compatibility with polyamide-6,6; obtained as CHOPVANTAGE ™ HP |
| | 3540 from PPG. |

Compositions are summarized in Table 2. Compounding was conducted on a 30 millimeter internal diameter ZSK twin-screw extruder at a melt temperature of 250 to 270° C. and a throughput of 15 kilograms/hour. All components except polyamide and glass fibers were mixed by high-intensity Henschel blender and the resulting dry blend was introduced at the throat of the extruder in the first feeder. Polyamide was fed via a second feeder, also at the throat of the extruder. Glass fibers were added further downstream in the extruder. The extrudate was pelletized.

Heat deflection temperature (HDT) values, expressed in units of degrees centigrade, were determined according to ISO 75-1:2004 using a load of 1.82 megapascals. Notched Izod impact strength values, expressed in units of kilojoules/meter², were determined according to ISO 180:2000 at 23° C. Tensile strength values, expressed in units of megapascals, were determined according to ISO 527-1:2012 at 23° C. Flexural modulus values and flexural strength values, each expressed in units of megapascals, were determined according to ISO 178:2010 at 23° C. Density values, expressed in units of grams/centimeter³, were determined according to ISO 1183-1:2004 at 23° C. Melt volume flow rate values, expressed in units of centimeter³/10 min, were determined according to ISO 1133:2011 at 280° C. and a 5 kilogram load.

The property results in Table 2 show that relative to Comparative Examples 1 and 2, inventive Examples 1, 2, and 3 exhibit higher heat deflection temperatures, increased tensile strengths, increased flexural modulus and flexural strength values, and increased melt flow values. Examples 1 and 3 further exhibit increased notched Izod impact strengths.

TABLE 2

| | | | | |
|---|---|---|---|---|
| C. Ex. 1 | Ex. 1 | C. Ex. 2 | Ex. 2 | Ex. 3 |

COMPOSITIONS

| | | | | | |
|---|---|---|---|---|---|
| PPE 0.46 | 29.78 | 0.00 | 29.31 | 19.44 | 18.36 |
| PPE 0.40 | 0.00 | 19.96 | 0.00 | 0.00 | 0.00 |
| CA | 0.45 | 0.60 | 0.44 | 0.60 | 0.58 |
| SEBS | 0.00 | 0.00 | 0.98 | 0.00 | 0.00 |
| AO 1 | 0.20 | 0.20 | 0.00 | 0.00 | 0.00 |
| AO 2 | 0.00 | 0.00 | 0.00 | 0.30 | 0.29 |
| AO 3 | 0.00 | 0.00 | 0.20 | 0.10 | 0.10 |
| Cu(OAc)₂•H₂O | 0.01 | 0.01 | 0.01 | 0.00 | 0.00 |
| CuCl₂•2H₂O | 0.01 | 0.01 | 0.00 | 0.00 | 0.00 |
| CuI | 0.00 | 0.00 | 0.01 | 0.00 | 0.00 |
| KI solution | 0.19 | 0.18 | 0.00 | 0.00 | 0.00 |
| CB 1 | 0.00 | 0.20 | 0.00 | 0.00 | 0.00 |
| CB 2 | 0.00 | 0.00 | 0.00 | 0.30 | 0.00 |
| CB MB 1 | 1.49 | 0.00 | 0.00 | 0.00 | 0.00 |
| CB MB 2 | 0.00 | 0.00 | 3.42 | 0.00 | 3.38 |
| PA66 1 | 0.00 | 0.00 | 0.00 | 39.38 | 0.00 |
| PA66 2 | 38.51 | 0.00 | 36.34 | 0.00 | 38.65 |
| PA66 3 | 0.00 | 38.92 | 0.00 | 0.00 | 0.00 |
| Glass fibers 1 | 0.00 | 0.00 | 0.00 | 39.88 | 0.00 |
| Glass fibers 2 | 29.36 | 39.92 | 29.31 | 0.00 | 38.65 |

PROPERTIES

| | | | | | |
|---|---|---|---|---|---|
| HDT (° C.) | 237 | 247 | 236 | 243 | 244 |
| Notched Izod | 8.9 | 12.1 | 10.6 | 9.8 | 11.7 |
| (kJ/m²) | | | | | |
| Tensile strength | 162 | 195 | 158 | 190 | 200 |
| (MPa) | | | | | |
| Flexural modulus | 8300 | 12416 | 8129 | 11208 | 11540 |
| (MPa) | | | | | |
| Flexural strength | 237 | 280 | 236 | 290 | 285 |
| (MPa) | | | | | |
| Density | 1.33 | 1.46 | 1.34 | 1.46 | 1.44 |
| (g/cm³) | | | | | |
| MVR | 5.4 | 8.2 | 6.3 | 10.0 | 9.5 |
| (cm³/10 min) | | | | | |

1. A molded article comprising a composition comprising:
45 to 65 weight percent of a compatibilized blend comprising the product of melt blending components comprising
30 to 44 weight percent of a polyamide-6, a polyamide-6,6, or a combination thereof,
12 to 23 weight percent of a poly(phenylene ether), and
0.1 to 1 weight percent of a compatibilizing agent; and
35 to 55 weight percent glass fibers;
wherein weight percent values are based on the total weight of the composition.

2. The molded article of claim 1, wherein the molded article is an automatic transmission oil cooler bracket, an under-the-hood support system, an under-car support system, an automotive battery tray, an electric vehicle support frame, an automotive roll-over crush zone component, an automotive powertrain housing, an automotive valve cover, an automotive intake manifold, an automotive turbo charger air intake manifold, an automotive turbo charger compressor housing, an automotive turbo charger compressor wheel, an automotive turbo charger compressed air duct, an automotive sunroof mounting or framework, an automotive window mounting or framework, an electric vehicle battery frame or support, an automotive load floor bracket or support, an automotive active grill shutter, an automotive grill opening reinforcement, an automotive mirror bracket, an automotive roof rack bracket or frame, an automotive running board component, an automotive fan support or housing or bracket, an automotive hood, an automotive hood fairing, an automotive hood trim support, an automotive seat structure, an automotive cabin structure or support or mounting device, an automotive storage container, an automotive throttle body housing, a water meter housing, a water distribution housing, a water valve, a water fitting, a water pump housing, a water filtration housing, or a water filtration support system.

3. The molded article of claim 1, wherein the polyamide is a combination of polyamide-6 and polyamide-6,6.

4. The molded article of claim 1, wherein the polyamide is polyamide-6,6.

5.-9. (canceled)

10. The molded article of claim 1, wherein the composition excludes flame retardants.

11. The molded article of claim 1, wherein the composition excludes electrically conductive fillers.

12. The molded article of claim 1,
wherein the composition consists of 55 to 65 weight percent of the compatibilized blend and 35 to 45 weight percent glass fibers; and
wherein the compatibilized blend consists of the product of melt blending components consisting of 35 to 45 weight percent of the polyamide-6,6, 16 to 23 weight percent of the poly(phenylene ether), 0.4 to 1 weight percent of the compatibilizing agent, and, optionally, 0.01 to 2 weight percent of an additive selected from the group consisting of antioxidants, stabilizers, mold release agents, lubricants, processing aids, dyes, pigments, anti-static agents, blowing agents, mineral oil, metal deactivators, antiblocking agents, and combinations thereof.

13. The molded article of claim 1,
wherein the poly(phenylene ether) comprises poly(2,6-dimethyl-1,4-phenylene ether);
wherein the compatibilizing agent is selected from the group consisting of citric acid, fumaric acid, maleic acid, maleic anhydride, and combinations thereof;
wherein the composition consists of 55 to 65 weight percent of the compatibilized blend and 35 to 45 weight percent glass fibers; and
wherein the compatibilized blend consists of the product of melt blending components comprising 35 to 45 weight percent of the polyamide-6,6, 16 to 23 weight percent of the poly(phenylene ether), 0.4 to 1 weight percent of the compatibilizing agent, and, optionally, 0.01 to 2 weight percent of an additive selected from the group consisting of antioxidants, stabilizers, mold release agents, lubricants, processing aids, dyes, pigments, anti-static agents, blowing agents, mineral oil, metal deactivators, antiblocking agents, and combinations thereof.

14. The molded article of claim 1, wherein the molded article is an automatic transmission oil cooler bracket.

15. The molded article of claim 1, wherein the molded article is an automotive under-the-hood support system.

16. The molded article of claim 1, wherein the molded article is an automotive under-car support system.

17. The molded article of claim 1, wherein the molded article is an automotive battery tray.

18. The molded article of claim 1, wherein the molded article is an electric vehicle support frame.

19. The molded article of claim 1, wherein the molded article is an automotive roll-over crush zone component.

20. The molded article of claim 1, wherein the molded article is an automotive powertrain housing.

21. The molded article of claim 1, wherein the molded article is an automotive valve cover.

22. The molded article of claim 1, wherein the molded article is an automotive intake manifold.

23.-50. (canceled)

51. A composition comprising:
45 to 65 weight percent of a compatibilized blend comprising the product of melt blending components comprising 30 to 44 weight percent of polyamide-6,6, 12 to 23 weight percent of poly(2,6-dimethyl-1,4-phenylene ether), and 0.4 to 1 weight percent of a compatibilizing agent comprising citric acid, fumaric acid, maleic acid, maleic anhydride, or a combination thereof; and
35 to 55 weight percent of glass fibers;
wherein weight percent values are based on the total weight of the composition.

52. The composition of claim 51,
wherein the composition consists of 55 to 65 weight percent of the compatibilized blend and 35 to 45 weight percent of the glass fibers; and
wherein the melt blended components consist of the polyamide-6,6, the poly(2,6-dimethyl-1,4-phenylene ether), the compatibilizing agent, and, optionally, 0.01 to 2 weight percent of an additive selected from the group consisting of antioxidants, stabilizers, mold release agents, lubricants, processing aids, dyes, pigments, anti-static agents, blowing agents, mineral oil, metal deactivators, antiblocking agents, and combinations thereof.
